(19) United States
(12) Patent Application Publication
(10) Pub. No.: US 2017/0132935 A1
(43) Pub. Date: May 11, 2017

(54) VEHICLE MANAGING METHOD BASED ON V2X AND SYSTEM THEREOF

(71) Applicant: Leauto Intelligent Technology (BEIJING) Co., Ltd., Beijing (CN)

(72) Inventors: Yong XU, Beijing (CN); Kunsheng CHEN, Beijing (CN); Peng LIU, Beijing (CN); Wei LIN, Beijing (CN); Wenrui LI, Beijing (CN)

(21) Appl. No.: 14/965,826

(22) Filed: Dec. 10, 2015

(30) Foreign Application Priority Data
Nov. 6, 2015 (CN) 201510752685.X

(51) Int. Cl. G08G 1/00; G06Q 30/06; G08G 1/16

(52) U.S. Cl. CPC G08G 1/202; G08G 1/205; G08G 1/16; G06Q 30/0645

(57) ABSTRACT

A vehicle managing method based on V2X and a system thereof are disclosed, the method includes: receiving a request message configured to requesting vehicle management; generating an instruction message matching the request message automatically; sending the instruction message to a to-be-managed vehicle via a V2X link to control the to-be-managed vehicle to perform operation indicated by the instruction message, and/or obtaining vehicle information of the to-be-managed vehicle fed back according to the instruction message. In the embodiment of the present disclosure, renting vehicle service process is simplified, and process efficiency is improved.

### CROSS-REFERENCE TO RELATED APPLICATIONS

The present disclosure is based upon and claims priority to Chinese Patent Application No. CN201510752685.X filed Nov. 6, 2015, the entire contents of all of which are incorporated herein by reference.

### FIELD OF TECHNOLOGY

The present disclosure generally relates to the field of vehicle electronic technology, and more particularly, to a vehicle managing method based on V2X and system thereof.

### BACKGROUND

As fast development of science and technology, automobile industry is also blooming. Nowadays, vehicles have been a type of transport media which they would prefer, vehicles not only serve as travel tools of personal commuting and traveling, etc., but also serve as shuttle bus of companies and schools, etc., which may provide great convenience for people.

Currently the renting vehicle service has to be finished by complex procedures, such as during renting vehicle, the user needs to prepare related credentials, go to renting vehicle company store, and finish operations such as credential verifying, paying advance deposit by credit cards, choose vehicle, examine the vehicle, deliver the vehicle etc. at the store. When returning the vehicle, he or she needs to drive the vehicle to specified returning place and calculate oil consumption, mileages, examine the vehicle, return the vehicle, checkout the payment and return the advanced deposit. Obviously, in the present renting vehicle service, the procedure of renting vehicle is long and complex, the business process speed is limited, especially when there are many users, it consumes much time for the users to wait. In addition, the renting company needs different working staffs to deal with different businesses, which increases the renting service cost.

### SUMMARY

Embodiment of the present disclosure provides a vehicle managing method based on V2X and system thereof, in order to solve the problem in the prior art that the procedure is long and complex, business processing speed is slow, renting service cost is high in the current renting vehicle service.

Embodiment of the present disclosure discloses a vehicle managing method based on V2X, including:

receiving a request message configured to requesting vehicle management;

generating an instruction message matching the request message automatically;

sending the instruction message to a to-be-managed vehicle via a V2X link to control the to-be-managed vehicle to perform operation indicated by the instruction message, and/or obtaining vehicle information of the to-be-managed vehicle fed back according to the instruction message.

Another embodiment of the present disclosure further discloses a vehicle managing system including:

a receiving module, configured to receive a request message for requesting vehicle management;

a generating module, configured to generate an instruction message matching the request message automatically;

a sending module, configured to send the instruction message to a to-be-managed vehicle via V2X link to control the to-be-managed vehicle to execute operation indicated by the instruction message, and/or obtaining vehicle information of the to-be-managed vehicle fed back according to the instruction message.

Another embodiment of the present disclosure discloses a A vehicle managing system including:

at least one processor;

a memory for storing at least one instruction executable by the processor;

wherein the processor is configured to:

receive a request message for requesting vehicle management;

generate an instruction message matching the request message automatically;

send the instruction message to a to-be-managed vehicle via V2X link to control the to-be-managed vehicle to execute operation indicated by the instruction message, and/or obtaining vehicle information of the to-be-managed vehicle fed back according to the instruction message.

In vehicle managing method of the V2X and system thereof disclosed in the embodiment of the present disclosure, after receiving the request message, it is capable to generate instruction message matching the request message automatically and then controlling the to-be-managed vehicle to execute the operation indicated by the instruction message and/or obtaining the vehicle information of the to-be-managed vehicle fed back according to the instruction message. That is, by the technical solution of the embodiment of the present disclosure, it is capable of finishing renting vehicle and returning vehicle procedures, simplifying renting vehicle service process, and improving processing efficiency. At the same time, users are independent from each other, renting service requests from different users can be processed simultaneously, thusly the efficiency is further improved. In addition, the user can obtain renting vehicle service without going to store, which also improves the efficiency of renting service and saves user's time. At the same time, renting vehicle service companies may reduce stores and staffs, which reduces the renting vehicle service cost.

### BRIEF DESCRIPTION OF THE DRAWINGS

In order to more apparently describe the technical schemes in the embodiments of the present disclosure or in the prior art, accompanying figures necessarily used in the description of the embodiments or the prior art will be simply explained hereinafter. Obviously, the accompanying figures described below will form the embodiments of the present disclosure. An ordinary person skilled in the art may conceive further figures in accordance with these accompanying figures without contributing creative labor.

FIG. 1 is a flow path showing the steps of the vehicle managing method based on V2X according to a first embodiment of the present disclosure;

FIG. 2 is a flow path showing the steps of the vehicle managing method based on V2X according to a second embodiment of the present disclosure;

FIG. 3 is a schematic diagram showing steps of renting vehicle process in the second embodiment of the present disclosure.

FIG. 4 is a schematic diagram showing steps of returning vehicle process in the second embodiment of the present disclosure.

FIG. 5 is a block diagram showing the structure of the vehicle managing system based on V2X according to a third embodiment of the present disclosure.

FIG. 6 is a block diagram showing the structure of the vehicle managing system based on V2X according to a fourth embodiment of the present disclosure.

FIG. 7 is a block diagram schematically showing the vehicle managing system according to the present disclosure.

FIG. 8 is a schematic diagram showing a memory for saving or carrying instructions according to the present disclosure.

### DESCRIPTION OF THE EMBODIMENTS

In order that objectives, technical schemes and advantages of the embodiments of the present disclosure become more apparent, the technical schemes in the embodiments of the present disclosure will be thoroughly and completely described below in conjunction with the accompanying figures in the embodiments of the present disclosure. It is obvious that the embodiments described herein are some of embodiments of the present disclosure rather than entire embodiments. On the basis of the embodiments of the present disclosure, other embodiments conceived by an ordinary person skilled in the art without creative labor would all fall into the scope of the present disclosure.

### The First Embodiment

Referring to FIG. 1, it is a flow chart showing the steps of the vehicle managing method based on V2X according to a first embodiment of the present disclosure.

In the embodiment, the vehicle managing method is mainly realized based on V2X, V represents vehicle, 2 represents to, X represents communication object such as vehicle, road, bicycle, passenger and the like. In the embodiment, as a new type communication method, V2X may access to a CAN (controller area network) bus network in the interior of the vehicle, and may send automatic diagnose control command to the vehicle to check the current state of the vehicle, and is independent from GNSS (Global Navigation Satellite System) signal, 2G (2-Generation wireless telephone technology) signal, 3G (3rd-Generation wireless telephone technology), 4G (the 4th Generation mobile communication technology) or 5G (5-Generation mobile communication technology) mobile communication network.

The vehicle managing method based on V2X including:

Step 101, receiving a request message for requesting vehicle management.

In the embodiment, the vehicle managing method based on V2X may be used in the situation including but not limited as renting/returning vehicle, the request message may be used in requesting starting renting vehicle service and starting changing vehicle service. Preferably, each to-be-managed vehicle includes a V2X communicating and managing module connected to the CAN bus of the vehicle, the to-be-managed vehicle mainly drives in intelligent roads and parked at intelligent parking lots, the intelligent roads and the intelligent parking lots mainly refer to roads or parking lots equipped with base station for realizing V2X communication; the communication protocol of the intelligent road and intelligent parking lot may be IEEE 802.11p.

Step 102, generating the instruction message matching the request message automatically.

In the embodiment, it is capable of generating instruction message matching the request message automatically according to the received request message. Wherein the instruction message may be used to control the vehicle to perform various kinds of operation such as unlocking, starting, shutting down, unlocking, recording driving information and performing safety monitoring to vehicle. The instruction message may also be used to request obtaining the vehicle information of the to-be-managed vehicle, to feedback the obtained vehicle information to the user, in order to allow the user to choose matched operation according to the vehicle information.

Step 103, sending the instruction message to the to-be-managed vehicle via the V2X link to control the to-be-managed vehicle execute the operation indicated by the instruction message, and/or obtain the vehicle information of the to-be-managed vehicle fed back according to the instruction message.

In the embodiment, each message of the to-be-managed vehicle can be transmitted by V2X link, and it is capable of finishing each kind of control operation to the to-be-managed vehicle and obtaining of vehicle state information.

To sum up, in the vehicle managing method based on V2X in the embodiment, after receiving the request message, it is capable of generating an instruction message matching the request message automatically, and then controlling the to-be-managed vehicle to execute the operation indicated by the instruction message and/or obtaining the vehicle information of the to-be-managed vehicle fed back according to the instruction message. That is, by the technical solution of the embodiment of the present disclosure, it is capable of finishing renting vehicle and returning vehicle procedures, simplifying renting vehicle service process, improving processing efficiency. At the same time, users are independent from each other, renting service requests from different users can be processed simultaneously, thusly the efficiency is further improved.

In addition, the user can obtain renting vehicle service without going to store, which also improves the efficiency of renting service and saves user's time. At the same time, renting vehicle service companies may reduce stores and staffs, which reduces the renting vehicle service cost.

### The Second Embodiment

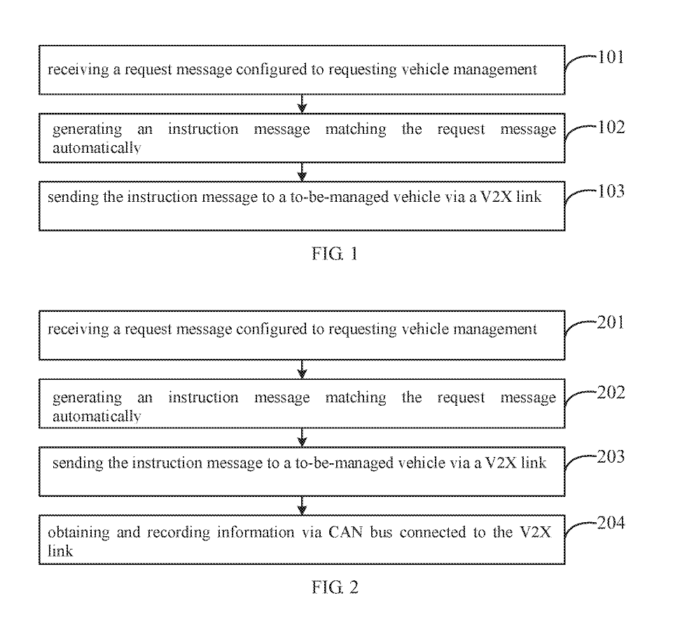

FIG. 2 is a flow path showing the steps of the vehicle managing method based on V2X according to a second embodiment of the present disclosure. In the embodiment, the vehicle managing method based on V2X may include:

Step 201, receiving a request message for requesting vehicle management.

In the embodiment, a cloud server may obtain request message sent via mobile terminal through current communication network (such as 2G or 3G network) or V2X link.

Step 202, generating instruction message matching the request message automatically.

Step 203, sending the instruction message to the to-be-managed vehicle via the V2X link, to control the to-be-managed vehicle to execute operation indicated by the instruction message, and/or obtaining the vehicle information of the to-be-managed vehicle fed back according to the instruction message.

In the embodiment, the management to vehicle mainly include: managing the to-be-managed vehicle during renting vehicle process, and managing the to-be-managed vehicle during returning vehicle process.

Renting Vehicle Process:

During renting process, it is capable of sending the first instruction message generated according to a first request message to the to-be-managed vehicle via V2X link; the first request message is used to request renting vehicle, the first request message includes a user's current position.

Preferably, step 203 may include: obtaining first vehicle information from the to-be-managed vehicle fed back according to the first instruction message, to allow the user to choose vehicle according to the first vehicle information. Wherein the first vehicle information includes: available vehicle amount information of the user's current position, the vehicle position information of each available vehicle and the vehicle state of each available vehicle. When the user's current position matches the vehicle position information of the user chosen vehicle, the user chosen vehicle is controlled to unlock and start, and start recording driving information via V2X link.

Returning Vehicle Process

During returning vehicle process, it is capable of sending a second instruction message generated according to the second request message to the to-be-managed vehicle, wherein the second request message is used to request returning the vehicle, the second request message includes a current position of the to-be-managed vehicle.

Preferably, the step 203 may include: controlling the to-be-managed vehicle to perform examination according to the second instruction message to obtain the second vehicle information, and obtaining a mileage charge calculated according to the current position of the to-be-managed vehicle, wherein the second vehicle information includes a vehicle state;

After determining the mileage charge is paid, controlling the to-be-managed vehicle to shut down and lock the vehicle via the V2X link.

In a preferred solution of the embodiment, the management to vehicle may also include managing the to-be-managed vehicle during driving process of the to-be-managed vehicle. Detailedly, the method may include:

Step 204, during driving process of the to-be-managed vehicle, obtaining and recording at least one type of information via CAN bus connected to the V2X link of: driving route, driving speed, battery level, fast acceleration information, fast deceleration information, collision information, and tire pressure information.

In order to be easily understood, in the embodiment, the vehicle managing method in the embodiment may be illustrated from renting vehicle process and returning vehicle process respectively. What should be noted is, renting vehicle and returning vehicle may be but not only refer to electric vehicle, the electric vehicle is mounted with V2X communication apparatus connected to the CAN bus of the vehicle, 802.11p communication signal covers the road and/or parking lot where the vehicle runs. By the V2X communication apparatus connected to the CAN bus, it is capable of performing the operations such as opening vehicle door, locking vehicle door, starting the vehicle, recording driving route, detecting vehicle safety state and controlling the vehicle lights. But the operations are not limited as above. Wherein detecting vehicle safety state includes but not limited as tire pressure monitoring, battery level detecting, fast acceleration recording, fast deceleration recording, over speed recording, collision recording.

Preferably, the renting vehicle process may be as follows:

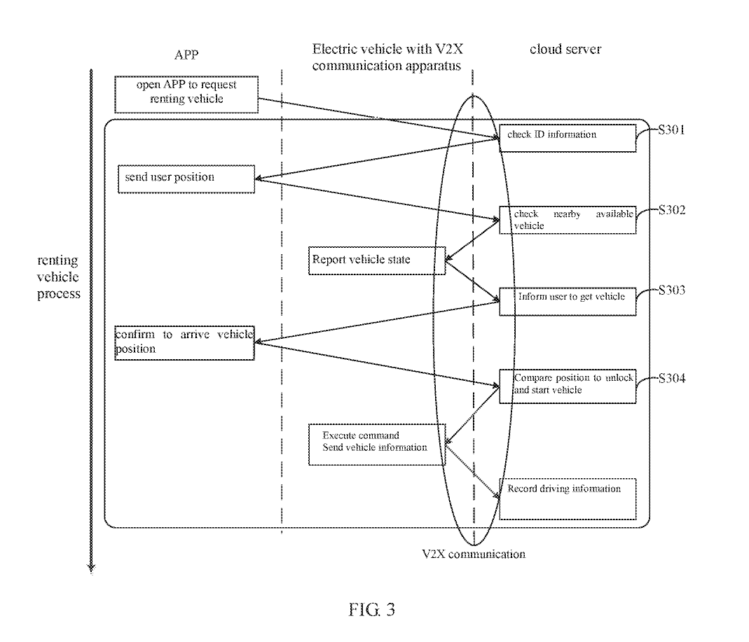

Referring to FIG. 3, it is a flow chart showing renting vehicle process in the second embodiment of the present disclosure. In the embodiment, the renting vehicle process path may be based on a user's APP (application), an electric vehicle disposed with V2X communication apparatus and a cloud server (a third party server providing renting vehicle service). Wherein the renting vehicle process may be as follows:

Step 301, the cloud server may identify the user's identity according to the received renting vehicle request.

In the embodiment, the user may set up a renting vehicle request via APP, wherein the renting vehicle request includes user information for identifying the user driving identity and driving qualification, but not limited thereto. The cloud server requests to obtain the user's current position information if determining the user identity meets the requirement of the driver; or end the flow path.

Step S302, determining the first vehicle information according to the user's current position fed back by the APP.

In the embodiment, the first vehicle information includes: amount information of available vehicle within a certain range (such as 200 m or 1000, which can be set according to actual situation, the present disclosure is not limited thereto), the vehicle position information of each available vehicle and the vehicle state of the available vehicle.

Step S303, generating information according to the first vehicle information to inform the user to get the vehicle.

In the embodiment, it is capable of pushing vehicles according to distance priority and/or vehicle state priority, in order to allow the user to choose to-be-rented vehicle from the pushed vehicles.

Step S304, monitoring the user's real-time position, when determining that the user's position matches the to-be-rented vehicle position, remotely controlling the vehicle to unlock, open the vehicle door and start.

What should be noted is, after the vehicle is started, it is also capable of controlling the vehicle to keep recording the vehicle's driving information, such as vehicle driving route, driving speed, battery level, fast acceleration information, fast deceleration information, collision information, tire pressure information and so on, in order to allow the renting vehicle company to determine the user and the vehicle according to the recorded driving information of the vehicle: such as determining the vehicle located position, evaluating the user (driver) operation behavior, determining whether the vehicle has accident.

Preferably, the returning vehicle process may be as follows:

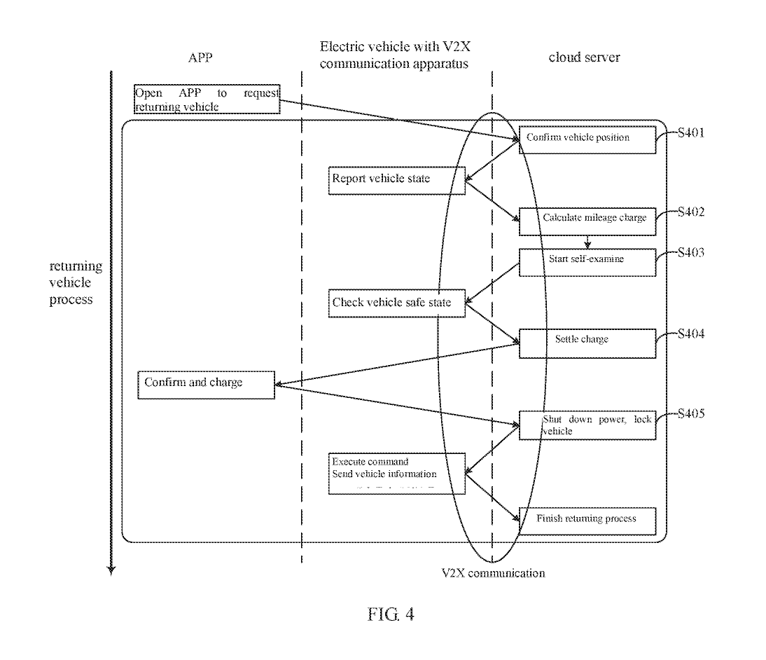

Referring to FIG. 4, it is a schematic diagram showing steps of returning vehicle process in the second embodiment of the present disclosure. In the embodiment, the returning vehicle process may be based on user's APP (Application), an electric vehicle equipped with V2X communication apparatus and a cloud server (a third party server providing renting vehicle service). Wherein the returning vehicle process may be as follows:

Step S401, after the cloud server receives return vehicle request, determining the position of the to-be-returned vehicle via V2X.

In the embodiment, the user may set up a return vehicle request via APP, based on intelligent road and intelligent parking lot, it is capable of determining the position of the to-be-returned vehicle.

Step S402, calculating mileage charge according to position of the to-be-returned vehicle.

Step S403, starting self-examine process to the to-be-returned vehicle.

In the embodiment, the self-examine process to the to-be-returned vehicle may include safety examination on tire pressure, engine state, vehicle body state, but it is not limited thereto, in order to ensure the safety and reliability of the vehicle.

Step S404, settling the charge and sending the settling charge to the user's APP.

In the embodiment, if the self-examine result is normal, the final settling charge is mileage charge. If the self-examine result is vehicle has error, a maintenance charge should be estimated according to error condition, the final settling charge includes at least the maintenance charge and the mileage charge.

Step S405, controlling the vehicle to shut down, turn off the power and lock the vehicle after determining the charge is paid.

To sum up, in the vehicle managing method based on V2X in the embodiment, after receiving the request message, it is capable of generating an instruction message matching the request message automatically, and then controlling the to-be-managed vehicle to execute the operation indicated by the instruction message and/or obtaining the vehicle information of the to-be-managed vehicle fed back according to the instruction message. That is, by the technical solution of the embodiment of the present disclosure, it is capable of finishing renting vehicle and returning vehicle procedures, simplifying renting vehicle service process, improving processing efficiency. At the same time, users are independent from each other, renting service requests from different users can be processed simultaneously, thusly the efficiency is further improved.

In addition, the user can obtain renting vehicle service without going to store, which also improves the efficiency of renting service and saves user's time. At the same time, renting vehicle service companies may reduce stores and staffs, thusly reduce the renting vehicle service cost.

Furthermore, the method in the embodiment may achieve information interact based on V2X communication, and independent from 2G, 3G, 4G or 5G mobile communication network, which ensures the communication efficiency and reduces communication cost of user. In addition, vehicle disposed with V2X communication apparatus may obtain real-time traffic condition, road, passenger and other traffic information during driving, which greatly increases driving safety.

To the embodiment of methods above, for described concisely, they are described as a series of action combination. However, a skilled person in the art may know that, the present disclosure is not limited to the described action sequence. Because according to the present disclosure, some steps may have other sequences or performed at the same time. Secondly, the skilled person in the art should also know that, the embodiments described in the specification are just preferred embodiments, the related action and modules are not necessary in the present disclosure.

### The Third Embodiment

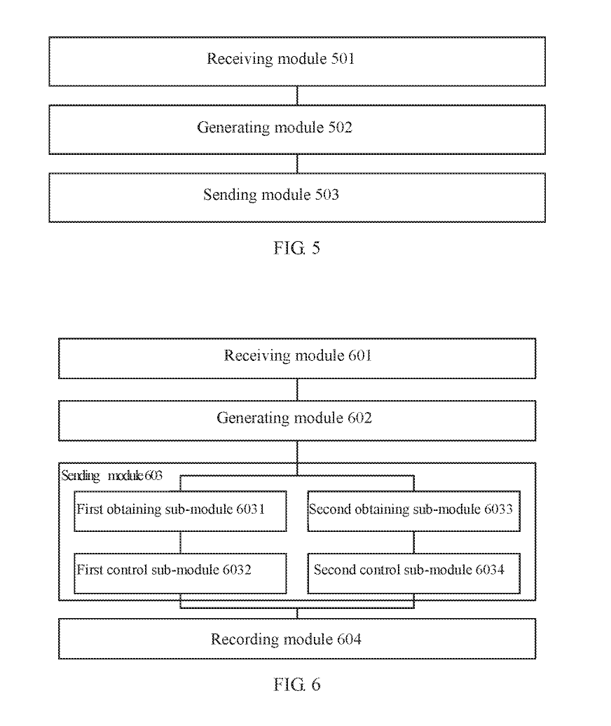

Referring to FIG. 5, it is a block diagram showing the structure of the vehicle managing system based on V2X according to a third embodiment of the present disclosure. In the embodiment, the vehicle managing system based on the V2X including:

a receiving module 501, configured to receive a request message for requesting vehicle management;

a generating module 502, configured to generate an instruction message matching the request message automatically;

a sending module 503, configured to send the instruction message to a to-be-managed vehicle via V2X link to control the to-be-managed vehicle to execute operation indicated by the instruction message, and/or obtaining vehicle information of the to-be-managed vehicle fed back according to the instruction message.

To sum up, in the vehicle managing system based on V2X in the embodiment, after receiving the request message, it is capable of generating an instruction message matching the request message automatically, and then controlling the to-be-managed vehicle to execute the operation indicated by the instruction message and/or obtaining the vehicle information of the to-be-managed vehicle fed back according to the instruction message. That is, by the technical solution of the embodiment of the present disclosure, it is capable of finishing renting vehicle and returning vehicle procedures, simplifies renting vehicle service process and improves processing efficiency. At the same time, users are independent from each other, renting service requests from different users can be processed simultaneously, thusly the efficiency is further improved.

In addition, the user can obtain renting vehicle service without going to store, which also improves the efficiency of renting service and saves user's time. At the same time, renting vehicle service companies may reduce stores and staffs, thusly reduce the renting vehicle service cost.

### The Fourth Embodiment

Referring to FIG. 6, it is a block diagram showing the structure of the vehicle managing system based on V2X according to a fourth embodiment of the present disclosure. The vehicle managing system based on V2X including:

a receiving module 601, configured to receiving a request message for requesting vehicle management;

a generating module 602, configured to generating an instruction message matching the request message automatically;

a sending module 603, configured to sending the instruction message to a to-be-managed vehicle via V2X link to control the to-be-managed vehicle to execute operation indicated by the instruction message, and/or obtaining vehicle information of the to-be-managed vehicle fed back according to the instruction message.

In the embodiment, the sending module 603 is concretely configured to: send a first instruction message generated according to the first request message to the to-be-managed vehicle via V2X link, wherein the first request message is configured to request renting vehicle, the first request message includes a user's current position; and send a second instruction message generated according to the second request message to the to-be-managed vehicle via V2X link, wherein the second request message is configured to request returning vehicle, the second request message includes the current position of the to-be-managed vehicle.

Preferably, the sending module 603 may include:

a first obtaining sub-module 6031, configured to obtain first vehicle information of the to-be-managed vehicle fed back according to the first instruction message to allow the user to choose vehicle according to the first vehicle information, wherein the first vehicle information includes available vehicle amount information of the user's current position, the vehicle position information of each available vehicle and the vehicle state of each available vehicle;

a first control sub-module 6032, configured to control the user chosen vehicle to unlock and start via the V2X link and starting recording driving information when the user's current position matches the vehicle position information of a user chosen vehicle.

In another preferred aspect, the sending module 603 may include:

a second obtaining sub-module 6033, configured to control the to-be-managed vehicle to detect according to a second instruction message, to obtain a second vehicle information, and obtain the renting vehicle charge calculated according to the current position of the to-be-managed vehicle, wherein the second vehicle information includes a vehicle state;

a second control sub-module 6034, configured to control the to-be-managed vehicle to be shut down and locked via V2X link after determining that the renting vehicle charge is paid.

In still another preferred aspect, the system may also include:

a recording module 604, configured to obtain and record at least one type of information via CAN bus connected to the V2X link of: driving route, driving speed, battery level, fast acceleration information, fast deceleration information, collision information and tire pressure information during driving process of the to-be-managed vehicle.

To sum up, in the vehicle managing system based on V2X in the embodiment, after receiving the request message, it is capable of generating an instruction message matching the request message automatically, and then controlling the to-be-managed vehicle to execute the operation indicated by the instruction message and/or obtaining the vehicle information of the to-be-managed vehicle fed back according to the instruction message. That is, by the technical solution of the embodiment of the present disclosure, it is capable of finishing renting vehicle and returning vehicle procedures, simplifying renting vehicle service process, and improving processing efficiency. At the same time, users are independent from each other, renting service requests from different users can be processed simultaneously, thusly the efficiency is further improved.

In addition, the user can obtain renting vehicle service without going to store, which also improves the efficiency of renting service and saves user's time. At the same time, renting vehicle service companies may reduce stores and staffs, which reduces the renting vehicle service cost.

Furthermore, the method in the embodiment may achieve information interact based on V2X communication, and independent from 2G, 3G, 4G or 5G mobile communication network, which ensures the communication efficiency and reduces communication cost of user. In addition, vehicle disposed with V2X communication apparatus may obtain real-time traffic condition, road, passenger and other traffic information during driving, which greatly increases driving safety.

The embodiments about devices are basically similar as the embodiments about methods, the description is relatively simple, the related parts may be referred to the embodiments about the methods.

Each member embodiment of the present disclosure can be realized by hardware, or realized by software modules running on one or more processors, or realized by the combination thereof. A person skilled in the art should understand that a microprocessor or a digital signal processor (DSP) may be used in practical use to realize some or all the functions of some or all the members of the apparatus for recognizing advertisement plug-ins according to the embodiments of the present disclosure. The present disclosure may be further realized as some or all the equipment or device programs for executing the methods described herein (for example, computer programs and computer program products). This program for realizing the present disclosure may be stored in computer readable medium, or have one or more signal forms. These signals may be downloaded from the Internet website, or be provided by carrying signals, or be provided in any other manners.

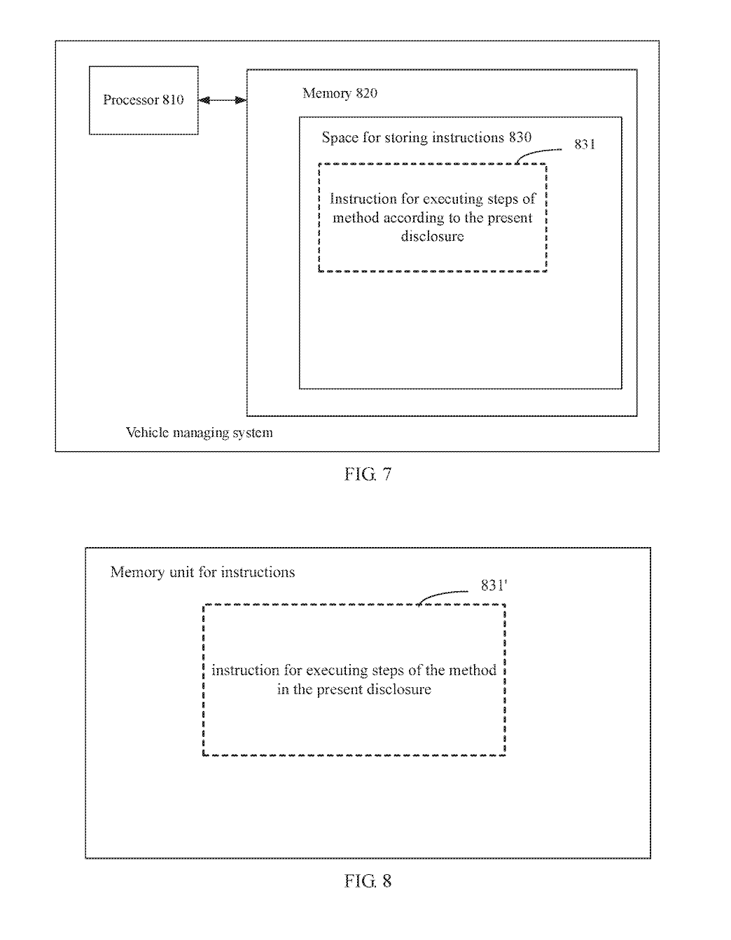

For example, FIG. 7 is a block diagram schematically showing a vehicle managing system for executing the methods of the present disclosure. The vehicle managing system conventionally includes a processor 810 and a computer program product or computer readable medium in the form of memory 820. The memory 820 may be an electronic memory such as a flash memory, EEPRPOM (electrically erasable programmable read-only memory), EPROM (electrically programmable read-only memory), hard disk or ROM (read-only memory). The memory 820 has a memory space 830 for storing instructions for executing any of the steps in the above method. For example, the memory space 830 for storing the instructions may include each instruction 831 for realizing steps in the above methods respectively. The instruction may be read out from one or more computer program product or write in one or more computer program product. The computer program product includes instruction carrier such as hard disk, compact disk (CD), storage card, or soft disk. The computer program product is usually a portable or non-portable memory unit shown in FIG. 8. The memory unit may have similar-arranged memory paragraph, memory space and the like as the memory 820 of the vehicle managing system in FIG. 7. The instructions may be, for example, compacted in appropriate form. Generally, the memory unit includes a computer readable code 831′, that is, the code which may be read by processor such as the processor 810. When the instruction is executed by the vehicle managing system, vehicle managing system is made to execute the steps in the methods above.

The device embodiment is described above merely for a schematic purpose, wherein the units explained as individual members may or may not be physically separated, the members shown as units may or may not be physical units and they can be located in a place or also can be distributed to network units. As necessary in practice, some or all of the modules can be selected to complete the objectives of the schemes of the embodiments. An ordinary person skilled in the art may understand and implement the embodiments without contributing creative labor.

Through above description of the implementations, it is obvious for the skilled in the art that the implementations can be completed by means of software in connection with necessary universal hardware platform or of course by means of hardware. Based on this understanding, the essence of aforesaid technical schemes or the part contributing to the prior art can be embodied in a form of software product. The computer software product can be stored in computer readable storage medium, such as ROM/RAM, magnetic disc, compact disc and the like, which contains a plurality of instructions such that a computing device (such as, personal computer, server or network apparatus) is able to execute the methods as described in the embodiments or a portion of the embodiment.

In the end, it should be explained that aforesaid embodiments are provided for the illustrative not limiting purpose of the technical schemes of the present disclosure. Although the present disclosure has been described in detail with reference to the embodiments, it should be understood that modifications or equivalent substitutions can be made to the technical schemes or some of technical features therein as disclosed in the embodiments by those skilled in the art; the modifications or substitutions will not bring the essence of the respective technical schemes to depart from spirit and scope of the technical schemes of the inventive embodiments.

1. A vehicle managing method based on V2X, comprising:
receiving a request message configured to requesting vehicle management;
generating an instruction message matching the request message automatically;
sending the instruction message to a to-be-managed vehicle via a V2X link to control the to-be-managed vehicle to perform operation indicated by the instruction message, or obtaining vehicle information of the to-be-managed vehicle fed back according to the instruction message.

2. The method according to claim 1, wherein the step of sending the instruction message to the to-be-managed vehicle via the V2X link comprises:
sending a first instruction message generated according to the first request message to the to-be-managed vehicle via V2X link, wherein the first request message is configured to request renting vehicle, the first request message comprises a user's current position;
and
sending a second instruction message generated according to a second request message to the to-be-managed vehicle via a V2X link, wherein the second request message is configured to request returning vehicle, the second request message comprises current position of the to-be-managed vehicle.

3. The method according to claim 2, wherein the step of sending the instruction message to a to-be-managed vehicle via V2X link to control the to-be-managed vehicle to perform operation indicated by the instruction message, and/or obtaining vehicle information of the to-be-managed vehicle fed back according to the instruction message comprises:
obtaining first vehicle information of the to-be-managed vehicle fed back according to the first instruction message to allow the user to choose vehicle according to the first vehicle information, wherein the first vehicle information comprises available vehicle amount information of the user's current position, the vehicle position information of each available vehicle and the vehicle state of each available vehicle;
when the user's current position matches the vehicle position information of a user chosen vehicle, controlling the user chosen vehicle to unlock and start and start recording driving information via the V2X link.

4. The method according to claim 2, wherein the step of sending the instruction message to a to-be-managed vehicle via V2X link to control the to-be-managed vehicle to execute operation indicated by the instruction message, and/or obtaining vehicle information of the to-be-managed vehicle fed back according to the instruction message comprises:
controlling the to-be-managed vehicle to perform examination according to a second instruction message, to obtain a second vehicle information, and obtaining a renting vehicle charge calculated according to the current position of the to-be-managed vehicle, wherein the second vehicle information comprises a vehicle state;
after determining that the renting vehicle charge is paid, controlling the to-be-managed vehicle to be shut down and locked via V2X link.

5. The method according to claim 1, wherein after sending the instruction message to the to-be-managed vehicle via V2X link, the method further comprises:
during driving process of the to-be-managed vehicle, obtaining and recording at least one type of information of the to-be-managed vehicle via CAN bus connected to the V2X link of: driving route, driving speed, battery level, fast acceleration information, fast deceleration information, collision information and tire pressure information.

6. A vehicle managing system comprising:
at least one processor;
a memory for storing at least one instruction executable by the at least one processor;
wherein the at least one processor is configured to:
receive a request message for requesting vehicle management;
generate an instruction message matching the request message automatically;
send the instruction message to a to-be-managed vehicle via V2X link to control the to-be-managed vehicle to execute operation indicated by the instruction message, and/or obtaining vehicle information of the to-be-managed vehicle fed back according to the instruction message.

7. The system according to claim 6, wherein the at least one processor is further configured to:
send a first instruction message generated according to the first request message to the to-be-managed vehicle via V2X link, wherein the first request message is configured to request renting vehicle, the first request message comprises a user's current position;
and
send a second instruction message generated according to the second request message to the to-be-managed vehicle via V2X link, wherein the second request message is configured to request returning vehicle, the second request message comprises the current position of the to-be-managed vehicle.

8. The system according to claim 7, wherein the at least one processor is further configured to:
obtain first vehicle information of the to-be-managed vehicle fed back according to the first instruction message to allow the user to choose vehicle according to the first vehicle information, wherein the first vehicle information comprises available vehicle amount information of the user's current position, the vehicle position information of each available vehicle and the vehicle state of each available vehicle;
control the user chosen vehicle to unlock and start and starting recording driving information via the V2X link when the user's current position matches the vehicle position information of a user chosen vehicle.

9. The system according to claim 7, wherein the at least one processor is further configured to:
control the to-be-managed vehicle to perform examination according to a second instruction message, to obtain a second vehicle information, and obtain the renting vehicle charge calculated according to the current position of the to-be-managed vehicle, wherein the second vehicle information comprises a vehicle state;
control the to-be-managed vehicle to be shut down and locked via V2X link after determining that the renting vehicle charge is paid.

10. The system according to claim 6, wherein the at least one processor is further configured to:
obtain and record at least one type of information via CAN bus connected to the V2X link of: driving route, driving speed, battery level, fast acceleration information, fast deceleration information, collision, tire pressure information during driving process of the to-be-managed vehicle.

11. The system according to claim 7, wherein the processor is further configured to:
obtain and record at least one type of information via CAN bus connected to the V2X link of: driving route, driving speed, battery level, fast acceleration information, fast deceleration information, collision, tire pressure information during driving process of the to-be-managed vehicle.

12. The system according to claim 8, wherein the at least one processor is further configured to:
obtain and record at least one type of information via CAN bus connected to the V2X link of: driving route, driving speed, battery level, fast acceleration information, fast deceleration information, collision, tire pressure information during driving process of the to-be-managed vehicle.

13. The system according to claim 9, wherein the at least one processor is further configured to:
obtain and record at least one type of information via CAN bus connected to the V2X link of: driving route, driving speed, battery level, fast acceleration information, fast deceleration information, collision, tire pressure information during driving process of the to-be-managed vehicle.

14. The method according to claim 2, wherein after sending the instruction message to the to-be-managed vehicle via V2X link, the method further comprises:
during driving process of the to-be-managed vehicle, obtaining and recording at least one type of information via CAN bus connected to the V2X link of: driving route, driving speed, battery level, fast acceleration information, fast deceleration information, tire pressure information.

15. The method according to claim 3, wherein after sending the instruction message to the to-be-managed vehicle via V2X link, the method further comprises:
during driving process of the to-be-managed vehicle, obtaining and recording at least one type of information via CAN bus connected to the V2X link of: driving route, driving speed, battery level, fast acceleration information, fast deceleration information, tire pressure information.

16. The method according to claim 4, wherein after sending the instruction message to the to-be-managed vehicle via V2X link, the method further comprises:
during driving process of the to-be-managed vehicle, obtaining and recording at least one type of information via CAN bus connected to the V2X link of: driving route, driving speed, battery level, fast acceleration information, fast deceleration information, tire pressure information.
